(19) United States
(12) Patent Application Publication
(10) Pub. No.: US 2010/0176914 A1
(43) Pub. Date: Jul. 15, 2010

(54) Control and Signaling Device for Vehicles

(76) Inventor: Aurelio Rotolo Moraes, Curitiba (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/908,180

(22) PCT Filed: Mar. 9, 2006
(86) PCT No.: PCT/BR06/00044

§ 371 Date: Mar. 19, 2010

(30) Foreign Application Priority Data
Mar. 10, 2005 (BR) PI0500758-5

(51) Int. Cl. G05B 23/02

(52) U.S. Cl. 340/3.1

(57) ABSTRACT

Describes an electronic device for controlling and signaling in automotive vehicles, preferably fastened onto the user's body. The remote device and object of the present invention 8,106,150,180,210,228, which is fastened onto the user's body by means of an adjustable elastic strap 82 or even a retractable and adjustable one 251,252, is able to send commands to the on-board computer 15, which are received by the communication system of the vehicle 7, processed and executed. The communication system of the remote device 29 can send or receive digital data, using radio frequency (RF), infrared light, ultrasonic waves or electric wiring/cabling as means of communication. Alerts and signaling may be performed by the remote device 8,106,150,180,210,228, through the vibratory signaling system 24, according to the commands sent by the vehicle's on-board computer 15. Its technical classification is under “electronics”.

This invention refers to a control and signaling device developed for use inside automotive vehicles, preferably while fastened onto the user's body. This invention is classified under the “electronics” sector.

The Patent Application BR0500758-5 of Sep. 3, 2005 and the Application priority with protocol No. 015060000986 of Sep. 2, 2006 at the INPI headquarters in Curitiba-PR Brazil, of the same applicant and whose inner priority is herein claimed. Said addition just adds some more technical innovations, which do not change the invention concept.

### DESCRIPTION OF THE STATE OF THE ART

The technological evolution and innovation in the automotive field, has brought comfort, safety, entertainment, more freedom and resources for both the driver and passengers of automotive vehicles. The complexity of mechanical elements, especially electronic ones, is forever increasing, yet the simplicity added together with the benefits of use is fundamental characteristics for the users.

In most state of the art automobiles, resources and functionalities such as: digital audio and video, satellite navigation systems, on-board computers, electronic adjustable seats, automatic transmission, etc. are included. The great challenge however, seems to be combining the access to all functionalities of the vehicle in one practical and simple control system, thus in turn making the user's interaction easier. Generally, the audio, video, air conditioner and on-board computer controls are located in the central panel, which in turn, makes it necessary for the user to reach out and focus their attention on the controls, causing both a distraction and a risk by having to take their eyes off the road for a moment. Some of these controls are placed on the steering wheel, however they may hinder driving in certain situations. Even though touch screen monitors represent an interesting option, they are placed on the central panel of the vehicle or next to the gear stick, also distracting the driver's attention.

The idea of the current invention is to concentrate the main controls of the vehicle on an easy to access operating device, which is preferably fastened onto the user's body, for instance, having the device fastened onto a user's leg, which enables the user to operate the on-board computer, entertainment system, air conditioner, engine variables, electronic system, among others, and also able to provide signaling to the user, who detects the vibration produced by the device, referred to any warning or a driving aid, depending on the situation. This way the electronic device of the present invention, preferably fastened onto the user's body, prevents lapses of attention, which could be potentially hazardous to both the driver and passengers, as well as permitting practical, comfortable, safe and intelligent interaction with the automobile's electronic systems. Having the option of attaching this device onto one's body, the person in the passenger seat is able to act as a navigator, performing secondary electronic, electrical and mechanical functional tasks. Performed on a daily basis, this would be an unprecedented act in the history of automotive vehicles. Therefore, the vehicle would be controlled by the driver and the passenger (navigator), which would result in a more inclusive control, and also guarantee the safety of the occupants, other vehicles and pedestrians as well.

### INVENTION OBJECTIVES

The purpose of this invention is to provide an automotive vehicle with an electronic device, to be fastened onto the driver's or passenger's body, enabling to control functions and resources of the vehicle, in addition to acting as an signaling of events including an alarm, speed limits, special signals, and the like. Other applications such as the interaction with instrumental and musical devices are also aimed at. It is hoped that the present invention might prevent lapses of attention in situations where the driver wishes to interact with the electronic systems of the vehicle, and make the act of driving and other integrated systems simple, accurate and comfortable. Besides producing easy to identify low noise warnings, the device of this invention may act as a driving aid.

### BRIEF DESCRIPTION OF THE INVENTION

The electronic device is based on the idea of having the main controls of an automotive vehicle 1 on a remote device 8, preferably fastened onto the user's body, aiming towards making interaction with vehicle's systems easier. The remote device 8 is presented in seven modalities 55,65,70,90,106,150,180,210,228 which aim at including all the spectrums of use while attending to the needs of the user. This device has an anatomical shape, providing the user with short cut keys 169,174,172,168, commands, spin disc and roll 205,225, pad 177, alphanumerical keyboard 76, display 32, among other elements. The commands are sent from the remote device 8, through its communication system 29, to the on-board computer 15, portable sound system 13, video game 14 and/or cellular phone 6, which are compatible with the communication system of the device 29. In the same way, information and commands can be sent by the on-board computer 15, and by other compatible devices.

The electronic device referred can be used to control several systems and devices of the vehicle such as the entertainment system 2, which may comprise a CD player, a radio (analog, digital or via satellite), a DVD player, or any other audio or video device. It can also be used to interact with the navigation system of the vehicle 12, also known as GPS (Global System Positioning), aiding in the navigation of maps, routes, selection and marks in general. Controlling specific variables of the vehicle is also possible through the on-board computer 15. In this case, the access is restricted to the driver, since some of those functions may constitute risk to safe driving. Such access is obtained through a password which must be typed on the alphanumerical keyboard 76. That also means that while the other occupants of the vehicle might still make use of the device, they will only have access to specific functions. The remote device 8 can act in the following elements of the vehicle: air conditioner, head lights, brake lights, turn signals, windshield wiper, cruise control, power windows/locks, gear shifting (in semi-automatic transmission), acceleration/traction control, among other controllable elements of the vehicle.

Another innovative functional characteristic of the device is its capability of vibration signaling. This kind of signaling enables the user to feel the vibrations produced by the device on the part of the body where it is attached. The advantages are obvious, compared to the sound signal systems found in most vehicles, which are either unnecessary or unpleasant to the other occupants of the vehicle, and should only concern the driver. Vibration signals may function as a warning system when an abnormal condition is detected, or in the case of danger, for instance, as in a sudden drop of tire pressure, lack of fuel, low engine oil levels, critical problems in a particular device, etc. Each type of signal can be configured in frequency, amplitude, and/or shape of mechanical wave, in a way that the detected signals can be easily distinguished by the user. A call to the user of the cellular phone 6 may produce a vibration signal on the remote device 8, through direct communication with the device 8 or though the vehicle's on-board computer 15. The device's alphanumerical keyboard 76 also allows the user make phone calls using his cellular phone 6, yet another innovation of the electronic device of this invention.

Another important feature which the vibration signaling 24 provides is the capability of assisting the driver in parking his car. Back up sensors, installed in the bumpers, can transmit the relative proximity of objects to the device 8. This information is then interpreted, and a vibration is produced according to the proximity, proportionally to amplitude, frequency, and/or interval between the mechanical vibrations emitted. This way, the driver can have an idea of the distance between the vehicles, thus making parking easier.

Vibration signaling 24 may also be useful to indicate that a particular speed limit has been reached. Once the remote device 8 interacts with the on-board computer 15, the information relating to the speed of the vehicle 1 can be sent to the device 8. Therefore, the remote device 8 is also capable of working as a speed controller, constantly monitoring the speed of the vehicle 1, informing through a vibration signal that a pre-set limit has been reached or exceeded. Let us suppose, for example, that the speed limit on a highway is 110 km/h (kilometers per hour). The driver sets this limit on the remote device 8. When the vehicle 1 nears this mark, the device 8 starts, gradually, producing vibrations, which can be felt by the user. As the speed limit is reached or exceeded, the vibrations become more intense. Several forms of vibration signaling 24 may be used, with the possibility of controlling its intensity, frequency and/or duration.

The adjustable elastic strap 82, which is part of the device 8, makes it possible for the user to fasten and adjust it to their body in the most suitable way. It comes with Velcro™ strips or adhesive portions 83,84,85,86. Another suggested kind of strap is comprised of an adjustable retractable elastic strap 251,252, which retracts automatically into the device 250, making it possible to fit the device 8,250 in a support 258 located inside the vehicle.

### BRIEF DESCRIPTION OF THE DRAWINGS

This invention will be hereafter described in further detail using the following drawings and diagrams, exploring all of its functionalities and resources. The figures show:

FIG. 1—is a general block diagram representing the automotive vehicle 1, inside which the remote device 8 is inserted, being the object of the present invention.

FIG. 2—is a detailed block diagram representing the remote device 20, in reference to its first and second modalities, being object of the present invention.

FIG. 3—is a detailed block diagram representing the remote device 40, in reference to its fourth modality, being object of the present invention.

FIG. 4—is a detailed block diagram representing the remote device 50, in reference to its fifth and sixth modalities, being object of the present invention.

FIG. 5—is a detailed block diagram representing the remote device 60, in reference to its third modality, being object of the present invention.

FIG. 6—is a detailed block diagram representing the remote device 55, in its seventh modality, being object of the present invention.

FIG. 7—is a frontal view of the first modality of the remote device 70, being object of the present invention.

FIG. 8—is a side view of the remote device 70, which is preferably attached to an adjustable elastic strap 82, in reference to its first modality, being object of the present invention.

FIG. 9—is a frontal view of the second modality of the remote device 90, being object of the present invention.

FIG. 10—is a side view of the second modality of the remote device 90, being object of the present invention.

FIG. 11—is a side view of the second modality of the remote device 100, featuring a distinctive way of attaching with the adjustable elastic strap 82, being object of the present invention.

FIG. 12—is a frontal view of the remote device 106, in reference to its first 20,70 and second 20,90,100 modalities, attached to an adjustable elastic strap 82, being object of the present invention.

FIG. 13—is a view of the frontal face 120 of the third modality of the remote device, being object of the present invention.

FIG. 14—is a frontal view of the third modality of the remote device 150, which is preferably attached to an adjustable elastic strap 82, being object of the present invention.

FIG. 15—views of the frontal face 164, upper side 160, lower side 162, right side 163, and left side 161 of the fourth modality of the remote device 40, being object of the present invention.

FIG. 16—is a frontal view of the fourth modality of the remote device 180, which is preferably attached to an adjustable elastic strap 82, being the object of the present invention.

FIG. 17—views of the frontal face 201, upper side 200, and lower side 202 of the remote device, being object of the present invention.

FIG. 18—is a frontal view of the remote device 210, which is preferably attached to an adjustable elastic strap 82, being object of the present invention.

FIG. 19—views of the frontal face 222 and left side 221 of the sixth modality of the remote device, being object of the present invention.

FIG. 20—is a frontal view of the sixth modality of the remote device 228, which is preferably attached to an adjustable elastic strap 82, being object of the present invention.

FIG. 21—is a side view of the body of the device 250, which has a retractable adjustable elastic strap 251,252.

FIG. 22—is a frontal view of the body of the device 250 with the retractable adjustable elastic strap 251,252 stretched.

FIG. 23—is an upper view of the body of the device 250 fit into a support 258 located inside the vehicle 260, noticing that the retractable adjustable elastic strap 251,252 is retracted, representing another modality for the adjustable elastic strap 82, and an alternative disposition for the device object of the present invention.

FIG. 24—is a view of the interior of an automotive vehicle, in which each user has a remote device 180,150 fastened onto their body, being object of the present invention.

### DETAILED DESCRIPTION OF THE FIGURES

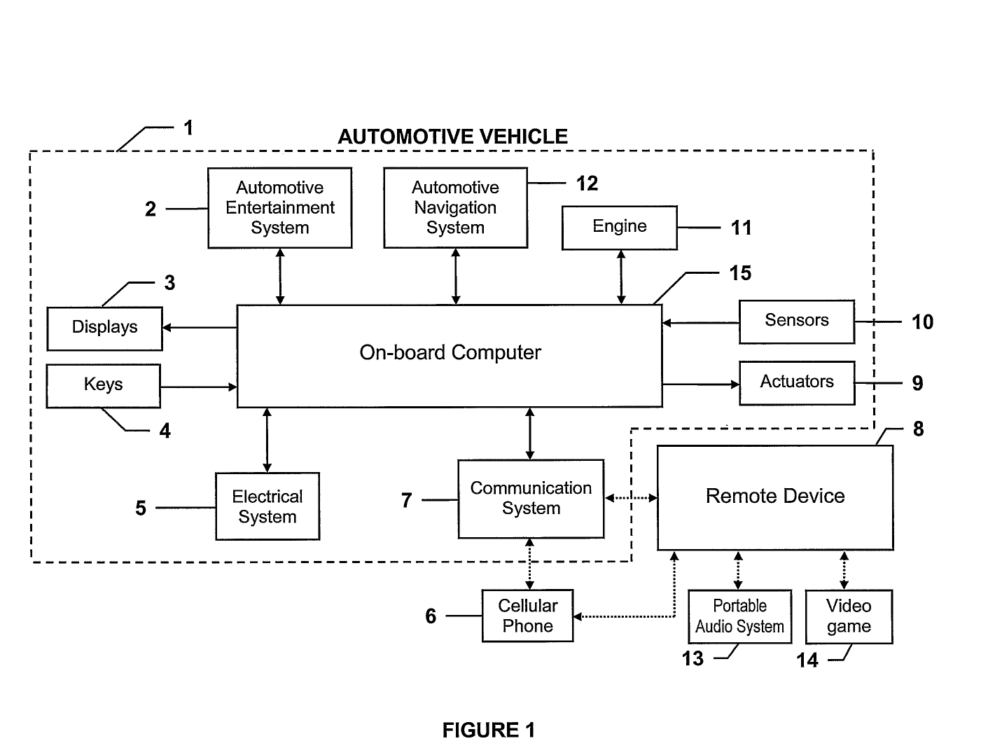

The device acts as an extension of the commands offered by the electronic system or the on-board computer of an automotive vehicle. Assuming a vehicle with several kinds of features, as shown in FIG. 1, in which the on-board computer 15 interacts with most of the available systems. The intention is to present just a sample of the functionalities and variables of the vehicle that can be controlled through the remote device 8, which is preferably fastened onto the user's body in order to interact with the communication system of the vehicle 7.

Keyboards 4 for entering data are arranged on the panel of the vehicle, and also on the steering wheel, and dials or displays 3 are located in suitable places. The on-board computer usually acts on the command of the electrical system 5, which is comprised of the essential devices of visual signaling, lighting, ignition, alarm, windshield wipers, among others. The cruise control and the access to engine variables make it demand that the on-board computer and/or other subsystems should control and obtain information from the engine 11, as well as the sensors 10 of the air conditioning, alarm, doors, etc. The control of the electrical and mechanical elements such as air conditioning valves, power door locks, power seats, among others, can be performed through actuators 9.

Digital entertainment technology has taken resources which were once used only at home or in computers, to automotive vehicles, for instance, DVD players, MP3 players, 3D surround audio systems, next generation video games, besides allowing audio and video to be picked up anywhere inside the vehicle. Satellite navigation systems (GPS—Global Positioning System), are also becoming more prominent. Thus, the on-board computer 15 may interact with the automotive entertainment system 2, and the vehicle navigation system 12, making it even easier to operate them. The user's cellular phone 6 may also be controlled by the on-board computer 15, through a compatible communication system 7, making use of the vehicle sound system so that the user may be able to make or receive phone calls, listen and talk at a distance through this device.

The remote device 8, object of the present invention, communicates with the on-board computer of the vehicle 15, through the communication system 7, making it possible to control, receive commands and/or information, indirectly, from the entertainment system 2, navigation system 12, engine parameters 11, actuators 9, electrical system 5, and cellular phone. It is important to point out that the cellular phone 6 can be operated and/or send commands or information directly to the remote device 8, as well as to a portable sound system 13, or a video game 14, which also send audio/video signals to the inputs of the entertainment system of the vehicle 2.

Although there is a display on the remote device 8, the user may prefer only to handle this device and visualize the correspondent events on graphic display or monitor located on the instrument panel. Head-up displays consist of a system which projects a visual screen on the windshield of the vehicle, typically on the central or lower left part, making it easier to visualize keys, windows, menus and other graphic objects that may be projected. Through a Head-up display the driver can visualize a graphic screen in an appropriate place on the windshield, and perform selections, menu browsing, adjustments, among other options, making use of the remote device 8. Therefore, the driver or passenger will handle the remote device 8 fastened onto their body and visualize the display with the commands on the windshield, what allows them to keep focused on the traffic and also makes it easier to move the hand, which is dealing with the device, to the steering wheel, gear shift or hand brake.

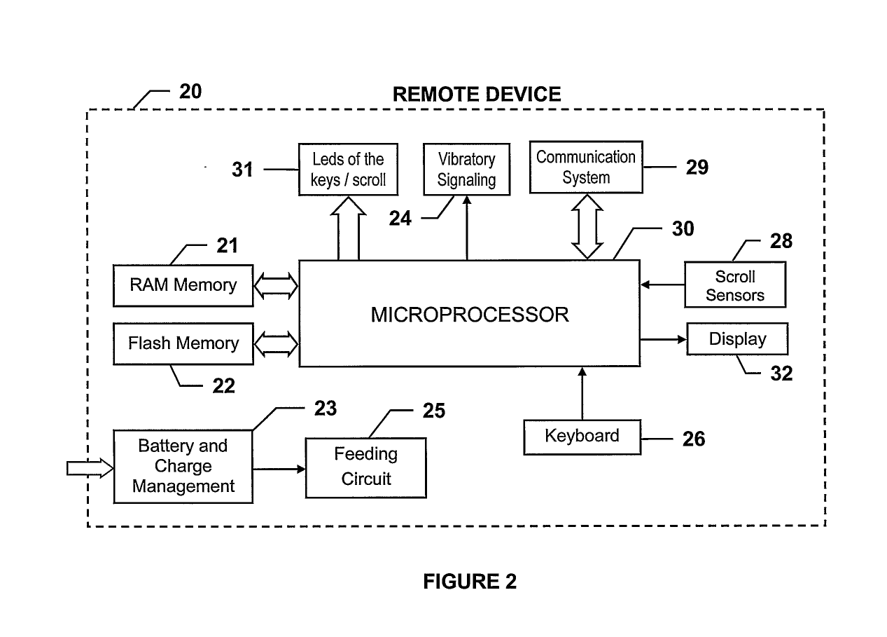

FIG. 2 shows the detailed block diagram of the remote device 20, in reference to the first and second modality of the device object of the present invention. This device is fed by an internal rechargeable battery and a battery management system 23 which, through the feeding circuit 25, supplies the necessary regulated tensions to feed other circuits.

The microprocessor 30 controls all the internal devices and circuits. It directly accesses the following kinds of memories: Flash memory 22, which stores the embedded software or the system's firmware and data; RAM (Random Access Memory) 21, which temporally stores processing data. The readout of all press-keys of the keyboard 26 is carried out by the microprocessor 30, which also controls the display 32. Through the keys found in the device, it is possible to select functions, adjust parameters, directly access the systems of the vehicle, among other possibilities which will be dealt with later on. The display 32 shows the user the most relevant information, such as: entertainment system 2 audio and video adjustments, graphic equalizer, air conditioning parameters, fuel level, menus, submenus, symbols, adjust options, the status of several elements of the vehicle that can be monitored, and is also capable of acting as a display extension for a cellular phone 6, an on-board computer 15, a GPS 12, a portable sound system 13, and a video game 14.

The scroll sensors 28 are associated to a wheel called scroll 75, similar to the ones used in computer mouse. Those sensors, preferably optical, can detect the rotation steps performed on this disc/wheel, helping in the selection of functions, icons, symbols, intensity adjustment of several types of parameters, and in the browsing of menus and submenus. LEDs (light-emitting diodes) 31 are placed below the semitransparent or transparent surface of the keys and of the scroll wheel 75, in order to provide luminous indication to the user, in reference to the action that needs to be taken, a key to be pressed, an abnormal condition alert, indicating when a parameter has reached its maximum or minimum, among other possible functionalities.

The vibratory signaling 24 consists of a component, attached to the structure of the device 8,20, with the purpose of producing mechanical vibrations on its structure, which will be transmitted to the user when in contact with their body. The element which is responsible for emitting mechanical vibrations may be a micromotor, a solenoid, or any other eletromechanical device capable of producing proper mechanical vibrations to attract the user's attention. The vibratory signaling 24 is controlled by the microprocessor 30, which acts on the control of the intensity, frequency and duration of the emitted vibrations. Through this resource, it is possible to provide the user with vibratory signals, such as any kind of alert, indication of functions, signaling a phone call, text message or photograph received on the cellular phone, among other possible kinds of signaling and indication. This innovative idea represents an alternative mean for the user of the remote device 8,20 perceive this kind of indication, without disturbing the other occupants of the vehicle with unwanted sound or luminous signals.

The communication between the remote device 8,20 and the vehicle 1 is performed through the communication system 29, which is compatible with the communication system of the vehicle 7. This system 29 allows for data communication in a bidirectional way (two-way), which may be done through radio frequency (RF), ultra sound, infrared light and/or electric wiring/cabling. In addition to that, communication system 29 also establishes communication with other compatible devices such as cellular phone 6, portable sound system 13, or video game 14. If the on-board computer 15 is connected to a wireless communication system 7, with Bluetooth™ technology (RF), the remote device 8,20 with compatible system will be able to act on the functions and resources made available by the vehicle 1.

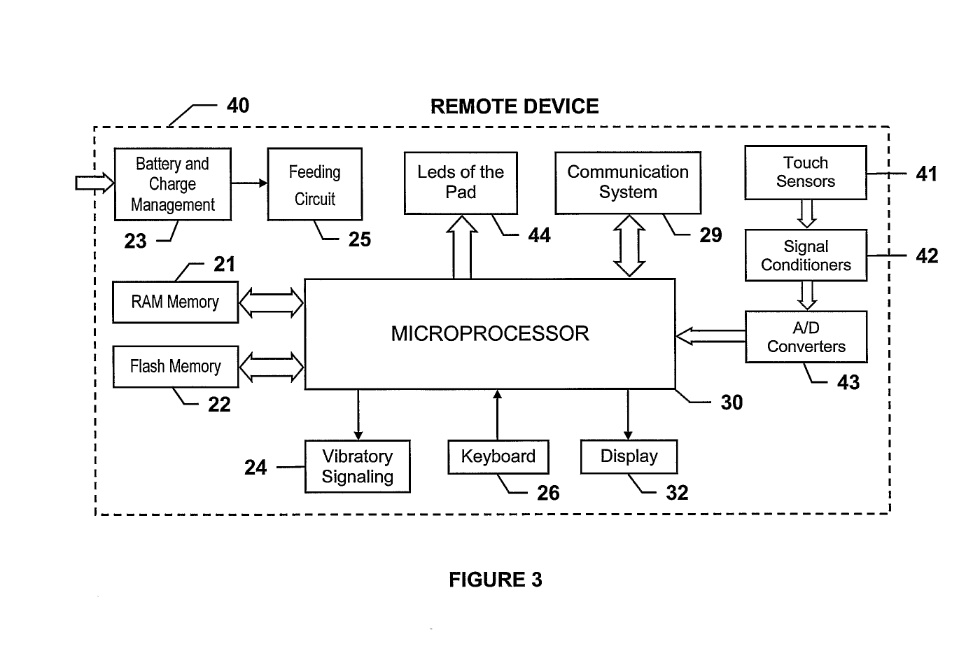

FIG. 3 presents a detailed block diagram of the fourth modality of the remote device 40, characterized for having a touch-sensitive region or pad 177. This modality allows for the user to move a cursor on a display, perform selections and functions by moving their finger over the surface of the pad 177. Besides the blocks depicted previously, this device includes the use of touch sensors 41, which are located right under the pad 177, and make it possible to detect the position or coordinate relative to the touch, as well as its intensity and duration. These sensors are arranged in the form of a matrix or in regions, and can be piezoelectric, capacitive, resistive, inductive, optical or field effective type, or still consist of pressure, force or position sensors. The analog signals produced by those sensors 41 pass through a signal conditioner circuit 42 and are converted into digital words through an analog-to-digital converters or A/D converters 43. The converted data is read, interpreted and processed by the microprocessor 30, which provides the position, intensity and duration of the touch. Those parameters are sent to the connected device (on-board computer, cellular phone, video game, or portable sound system) through the communication system 29.

The display 32 may be linked to the pad 177, showing keys or selection options. It can recognize the touch as it aggregates the pad 177 right under its surface just like a touch screen display. In case display 32 is not linked to the pad 177, leds 44 are arranged under the transparent or semitransparent surface of pad 177 providing visual indication regarding places to touch, signaling, visual alarms, and also form geometric figures such as arrows, circles, rectangles, symbols, icons, characters, numbers, among other figures. The information in order to command the lighting of the leds 44, as well as the control of the vibratory signaling 24 and other devices, comes from the vehicle's on-board computer 15, or the compatible equipment connected by means of the communication system 29.

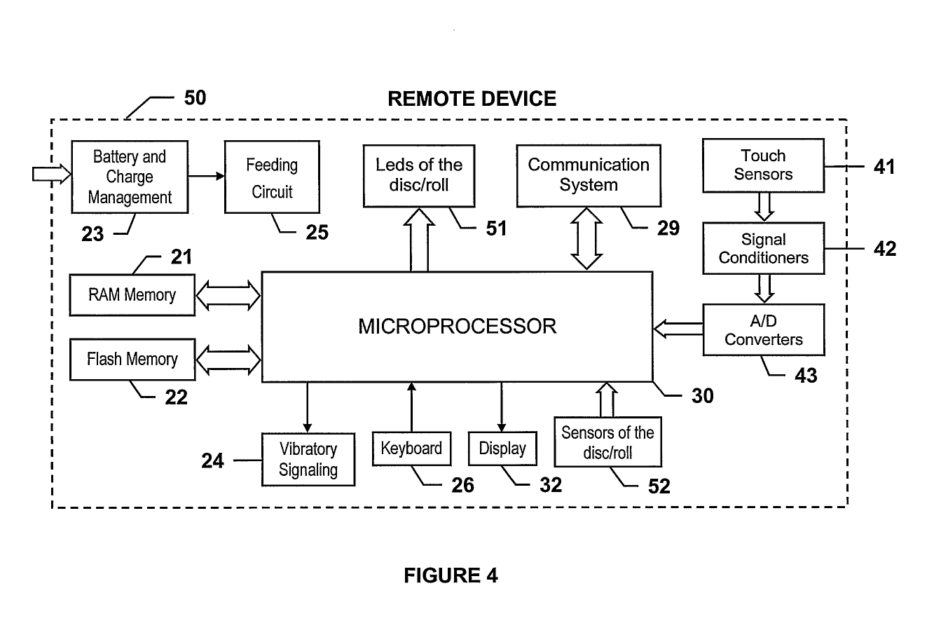

The fifth and sixth modalities of the remote device 50 are shown in detail by the block diagram of FIG. 4. The fifth modality 210 has a multifunctional disc 205, which is sensitive to the touch and rotation applied (it doesn't spin by itself), making menu browsing, function selection and parameters adjustment in an easy and efficient way. The touch sensors 41 are arranged under the surface of the disc 205, just like the leds 51, which have the same functionalities as previously mentioned. The arrows and symbols, with controllable intensity and duration, formed through the leds 51, allow for the user to perceive the direction and speed of the rotation that should be applied to the disc 205. In the sixth modality of device 228, there is a multifunctional roll 225, which also has a sensitive touch surface, distributed leds 51, and it is also capable of detecting the applied rotation (it doesn't spin by itself). The leds 51 indicate the rotational direction and the intensity of which the visual effects are produced in order to provide the appropriate indications. Several colors may be produced by the leds 51, depending on the kind of indication that will be shown. The other blocks of this diagram are identical to the ones mentioned; therefore they will not be dealt with again. The sensors found in disc/roll 52 detect the rotation applied to the disc/roll, and may consist of position and/or angular speed, optical, inductive, or capacitive sensors.

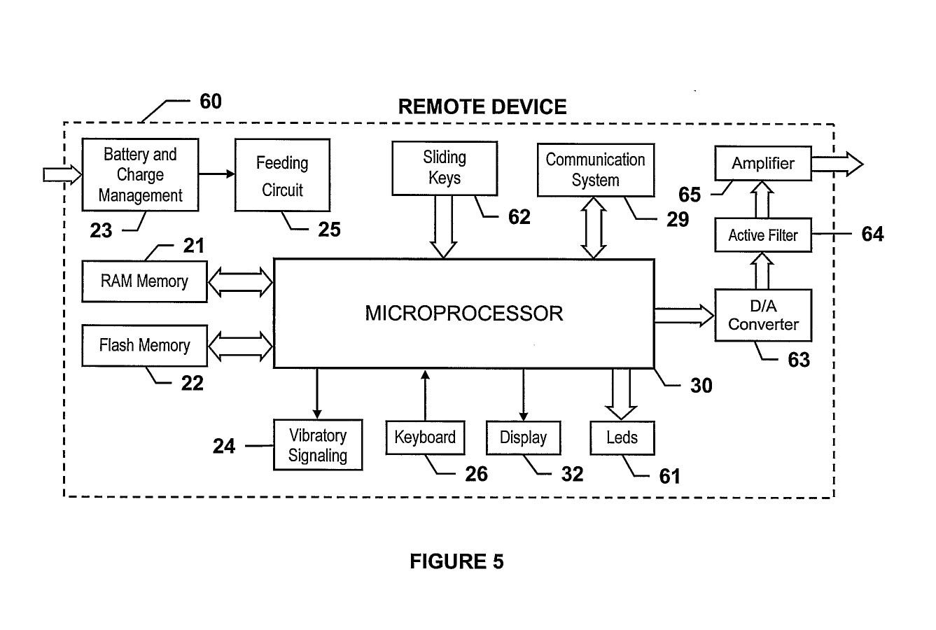

FIG. 5 illustrates the block diagram of the third modality of the remote device 60, which has an interface for sound adjustments, but can also perform other functionalities described to the other modalities. With this device 60, it is also possible to control one or more portable sound systems 13 aimed at producing instrumental sounds (percussive, keyboard, string or wind instruments), accompaniment, and playing of songs as, for instance, the device described on the patent application PCT/BR2005/000210. According to this patent application, the portable device presented is capable of producing instrumental sounds to accompany a song, among other functions. Another kind of instrumental device, for use inside automotive vehicles though, described on the patent application PCT/BR2005/000209, can be also controlled by the remote device of this modality 60. Besides that, the remote device 60 can also interact with a cellular phone which has musical instruments resources, as mentioned on the patent application PCT/BR2006/000012. Therefore, this third modality of the device of the present invention 60 makes it possible to control functions and parameters of instrumental devices in the most different situations, either fastened or not onto the user's body, again either in or out of the automobile.

The third modality 60 stands out for its audio adjustment sliding keys 62 which may consist of resistive potentiometers, optical displacement sensors, or any other kind of sliding adjustment. The microprocessor 30 performs the analog or digital readout of these devices, resulting in a particular value in the adjustment scale, being sent to the entertainment system of the vehicle 2, which interprets and carries out the parameter adjustment. Sounds coming from the entertainment system 2 can also be sent to the remote device 60, through the communication system 29, so that the user is able to listen to them through the use of headphones which are connected to the device. The data received through the communication system 29, referred to the sounds received by the remote device 60, is decoded by the microprocessor 30, which sends it to the digital-to-analog converter or D/A converter 63. The analog signals resulting from the D/A converter 63 pass through an active filter 64, which eliminates noise and limits the output frequency range, and are amplified by the audio amplifier 65. The entertainment system 2 signal is then recomposed in the remote device 60 and sent to the external headphones. The leds 61 indicate the audio channels in such a way, so that when a led is lit up, the respective channel is on.

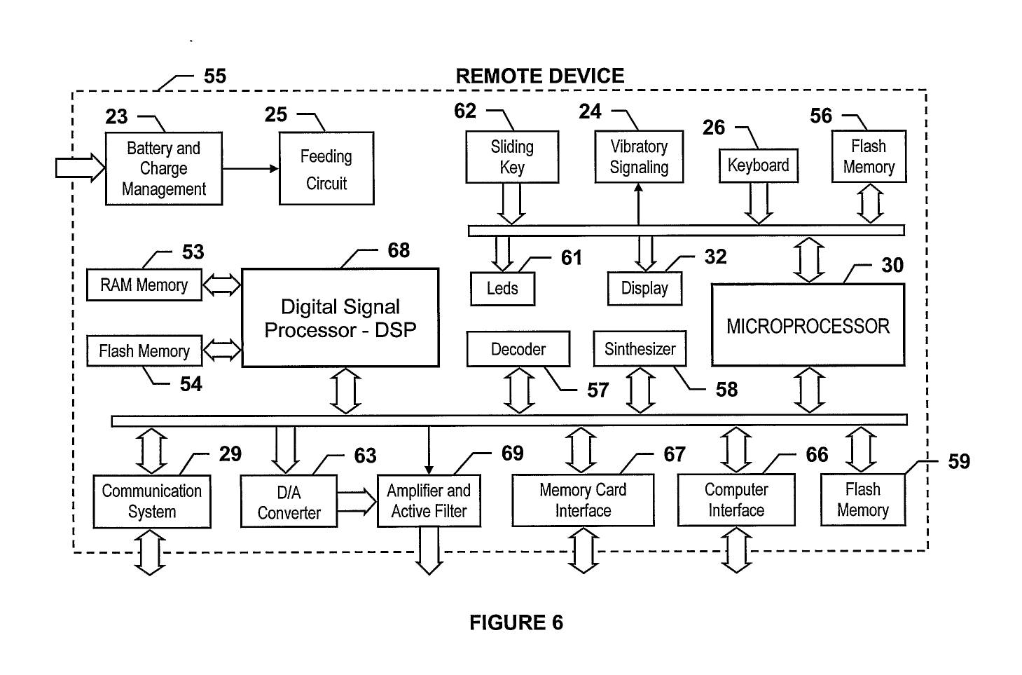

The seventh modality of the remote device 55 also allows for sounds to be received, processed and sent to the entertainment system 2 or another sound system as the block diagram of FIG. 6 highlights. With this option, the device 55 is able to receive commands from an electronic transducer, such as the one described in the granted U.S. Pat. No. 6,838,610B2, which describes a device with a sensitive touch surface that picks up the intensity and frequency of the user's touches, and sends the processed information to another device in order to produce instrumental sounds (percussive, keyboard, string or wind). In this case, the remote device 55 receives commands from an electronic transducer, processes them, and produces instrumental sounds (percussive, keyboard, string or wind), as well as making individual adjustment of sound parameters for each user of an electronic transducer. It is also possible to play a song and mix it with instrumental sounds relative to one or more electronic transducer. As with the third modality, the remote device 55 makes it possible to control instrumental devices, such as the ones described by PCT/BR2005/000210, PCT/BR2005/000209 and PCT/BR2006/000012, hence being able to receive sounds from these devices, process, and adjust them to result in a sound that can be sent to the entertainment system of the vehicle 2.

The remote device 55 features a Digital Signal Processor (DSP) 68 which can mix sounds, perform several kinds of digital audio processing (filter, distortions, equalization, mixing, instrumental sound production, sound effects, etc.) and interact with peripherals. Two types of memory are associated to the DSP 68: RAM memory 53, which stores temporary data referring to variables, sounds, etc. and; Flash Memory 54, which stores the firmware or the embedded software so that this device can perform its tasks. Songs or sound samples may be coded, zipped, or encrypted. In case the DSP 68 cannot perform the processing of this kind of data, the decoder 57 has resources to decode, unzip, or decrypt data, resulting in intelligible data to the DSP 68. As with the synthesizer 58, it works on the production of instrumental sounds (percussive, keyboard, string or wind), from musical parameter input, working with the DSP 68.

The flash memory 59 is intended to store songs, sounds, samples, files, among other information which can be accessed through the DSP 68 or the microprocessor 30. The computer interface 66 offers a communication port, compatible to any computer, enabling access to all the resources of the device, data reading and writing in the flash memory 59, besides facilitating firmware update. The device's memory capacity can be expanded through a memory card. In this case, the memory card interface 67 provides connection means to several kinds of cards, permitting the device to perform all the necessary functions.

A selected sound source or the resulting sound of the remote device 55 can be heard in external headphones. In that case, the digitalized sound is turned into corresponding analog signals through the D/A converter 63, passing through filter circuit and amplifier 69, which perform the signal conditioning in order to stimulate external headphones, via headphones connector 132.

The microprocessor 30, which also interacts with the DSP 68, is responsible for the controlling and reading of peripherals, such as sliding keys 62, vibratorion signaling 24, keyboard 26, display 32, and leds 61, containing an associated flash memory 56 by way of storing the firmware of this subsystem. The communication system 29; volume control on the active filter and amplifier 69; and also memory card and computer interfaces 67,66, can be controlled by the microprocessor 30 as well.

The frontal face 70 of the first modality of the remote device is shown in FIG. 7. The device is composed of two parts 70,71 that slide against each other in order to make the alphanumeric keyboard 76, which is in the lower part, available. The scroll 75, two selection and/or command keys 73,74, and the graphic display 32 are found on the upper part 70. The alphanumeric keyboard 76 can be used for entering passwords, command codes, function numbers, and also function as the cellular phone keyboard 6, being that the display 32 becomes an extension of the telephone's display. When the upper part 70 superposes the lower part 71, the device is closed. The user is then able to put his hand on the upper part 70 in order to work with the keys 73,74 and on the scroll 75, just like on a computer mouse. The display 32 is covered by the user's hand, but he will use the vehicle's display as the visualization screen for any operations he may wish to perform.

FIG. 8 shows a lateral view of the first modality of the remote device 70, which is attached to an adjustable elastic strap 82. As one can see, the scroll 75 sticks out so that the user can rotate it. The display 32 can be seen on the upper part 70, which is transparent in the region where the display 32 is found. On both sides there is an auxiliary command and/or selection button 78, besides a button for opening 77, which unlocks both parts 70,71 so that the user may slide the upper part 70 and have access to the alphanumeric keyboard 76, which slightly sticks out. The connection between the lower part 71 and the adjustable elastic strap 82 is done through two attached discs 79,80 that slide against each other what makes it possible for the device to rotate around the strap 82, allowing the user to adjust the device in order to facilitate its operation.

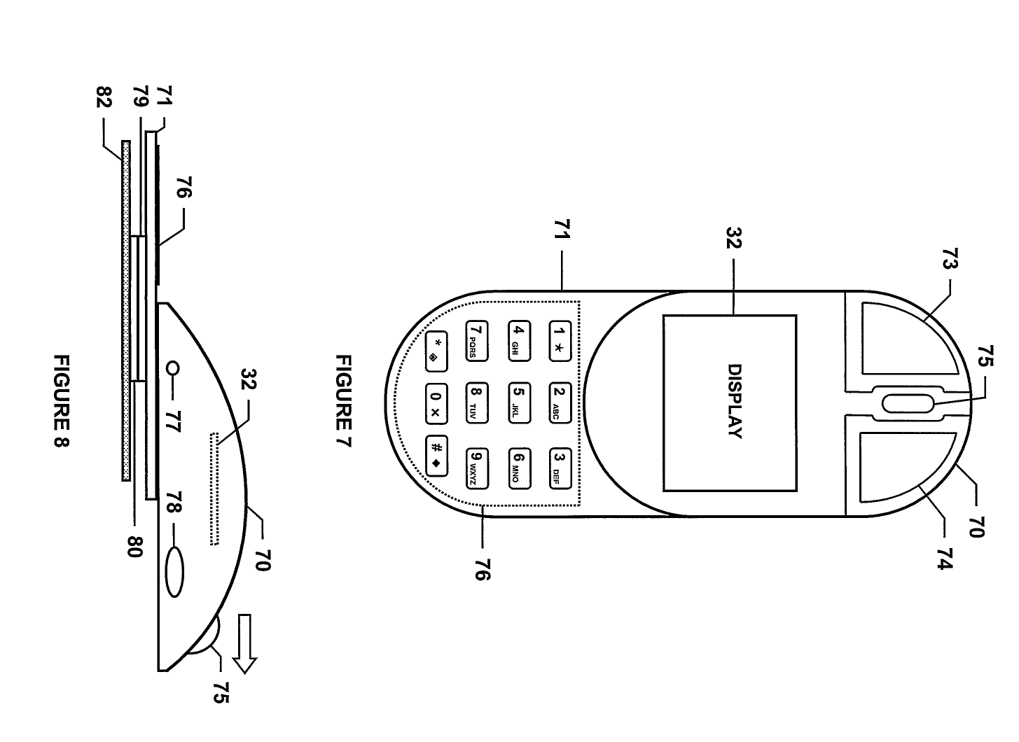

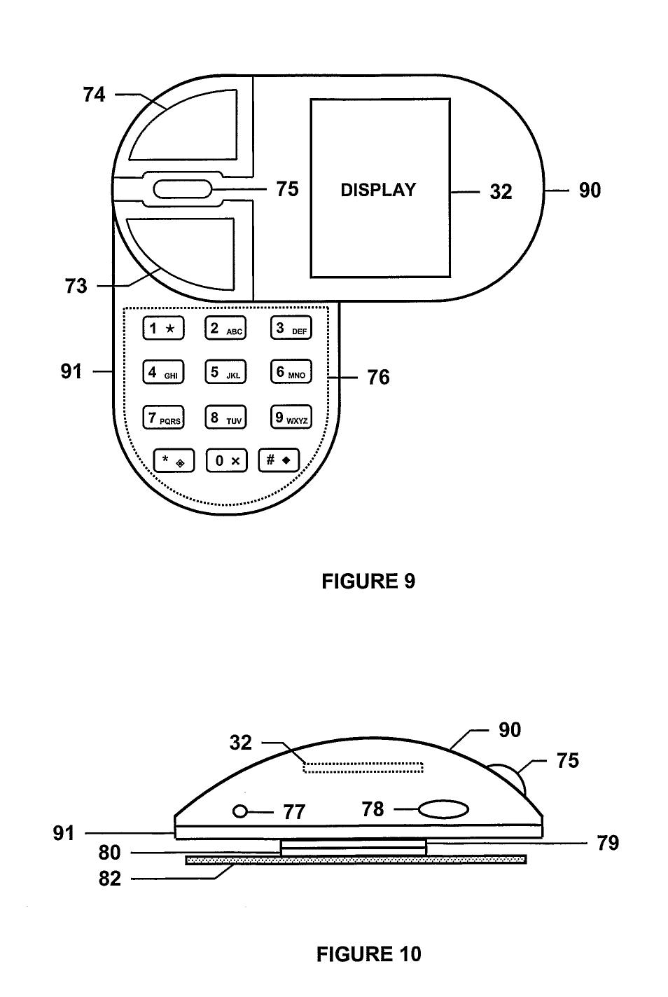

The frontal view of the second modality of the remote device 90 is illustrated in FIG. 9. In this modality both parts 90,91 rotate around each other on the upper extremity to allow access to the alphanumeric keyboard 76. The upper part 90, like in the first modality of the device 70, has two selection/command keys 73,74, a scroll 75, and a graphic display 32. FIG. 10 shows a lateral view of the device 90, which can be attached to the elastic strap 82 through two discs 79,80 which are connected and slide around each other, making the rotation of the device 90,91 around the strap 82 possible, in order to obtain a better adjustment.

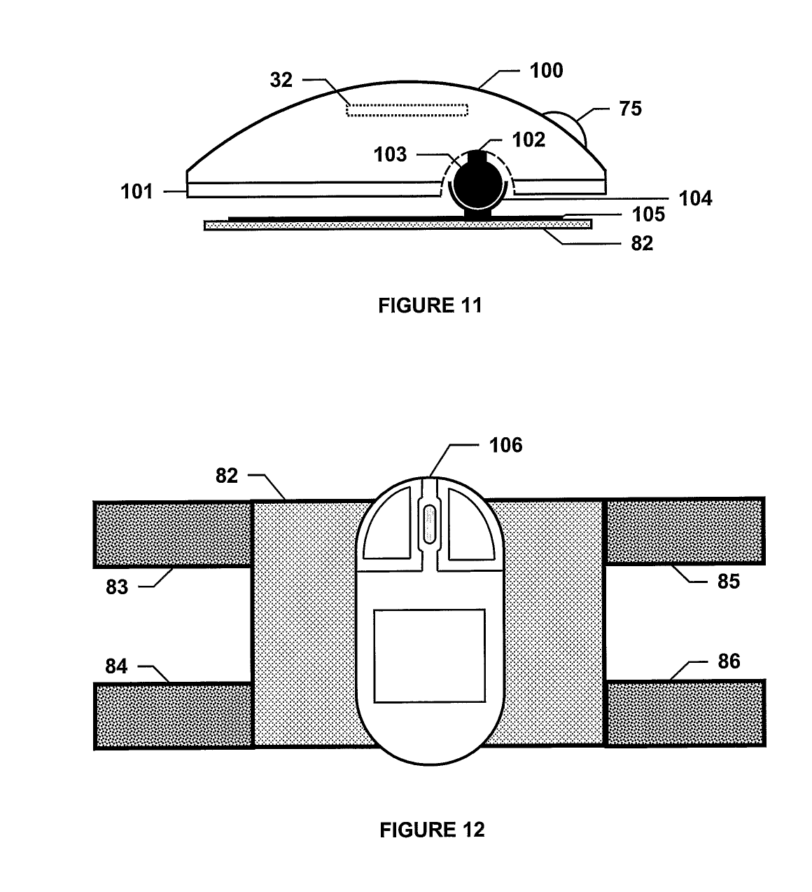

Another way of attaching the second modality of the device 90 to the adjustable elastic strap 82 is shown in FIG. 11. The side face shown suggests that the upper part of the device 100 should be attached to the strap 82 by means of an articulated mechanism 102,103,104,105. A pivot 102 comes out of the upper part 100 into a sphere 103 which fits by pressure into a support 104 attached to a base 105 which is fixed to the adjustable elastic strap 82. In this manner, the user can move the device 100,101 around the strap 82 and adjust it in a more precise way.

FIG. 12 presents a frontal view of the first 70 and second 90 modalities of the remote device 106 attached to a adjustable elastic strap 82, which has Velcro™ strips or adhesive portions 83,84,85,86 that allow the device 106 to be fastened onto the user's body. This characteristic represents one of the main innovations of the device of the present invention.

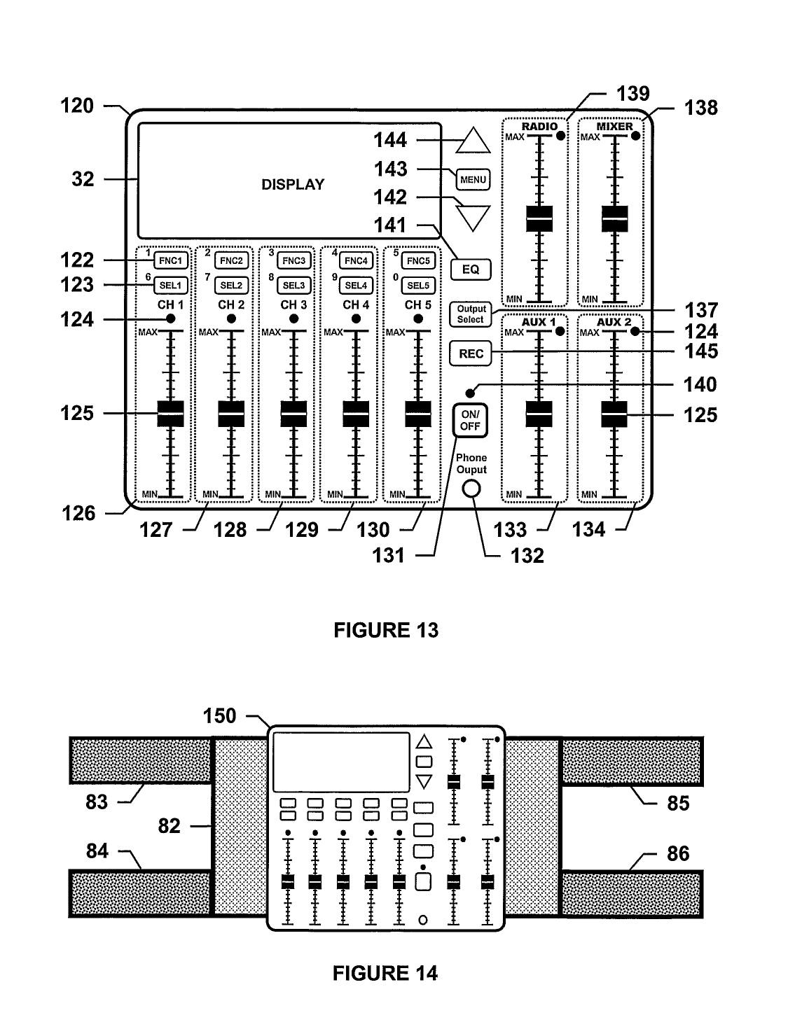

FIG. 13 shows the frontal face 120 of the third 60 and seventh 55 modalities of the remote device. These modalities may have five (or more) channels for individual audio adjustment 126,127,128,129,130, function keys, and both input and output channels adjustment. Taking the first channel 126, as a model for the others, which has a sliding intensity adjustment 125, a selection key 123, a selection indication led 124, and a function key 122. The channel is activated through the SEL1 key 123, being that the led 124 indicates this condition. The FNC key 122 allows for the selection of several functions, such as volume adjustment, balance, bass, treble, echo, distortion, attenuation, mixing, among other functionalities which can be altered through the sliding adjustment 125. The other individual channels 126,127,128,129,130 have the same characteristics, but act on a specific audio input or source. Besides that, the channels 126,127,128,129,130 can help in the sound equalization, through the EQ key 141, in which each channel is responsible for intensity adjustment of the response in the established frequency range for the respective channel. The SEL 123 and FNC 122 keys make it possible, as a secondary option, the input of numbers which may act on several functionalities, such as audio source selection, rhythmic instrument, musical instrument, parameters value setting, among other possibilities.

The MENU key 143 and browsing arrows 144,142 permit the access and browsing in menus, submenus, icons, sound adjustments, audio function operation, besides granting access to the vehicle's systems 12,5,2, etc. The channels 126,127,128,129,130 may also be used to make adjustments in the air conditioning, electric system 5, engine 11, GPS 12, among others. All the possible visualizations for the user are shown on the graphic display 32. The ON/OFF key 131 turns the device 120 on or off, being that there is a visual indication through the led 140 next to this key 131. The headphone connector 132 makes it possible for the user to connect an external headphone in order to monitor the processed or adjusted sounds.

The output sound, referring to one of the input channels or to the mixing of two or more channels, is selected through the Output Select key 137. The output channels 138,133,134 comprise sliding adjustments of intensity 125, and leds 124 for the selection indication. The AUX1 133, and AUX2 134 channels select two output options which may be formed by the selection of input channels 126,127,128,129,130 or any audio source. The RADIO channel 139 controls the audio volume input referred to the entertainment system 2, be it from the radio, CD player, MP3, or DVD player, which will come out of the remote device 120. The MIXER channel 138 corresponds to the intensity adjustment of a personalized output, which refers to the mixing of two or more audio signals. At last, the resulting audio signal or from a selected audio source can be recorded through the REC key 145. In the seventh modality of the remote device 55, the recording is carried out digitally in the form of data which are stored in the Flash memory 59, or in a memory card, with or without codification, operation of zipping and/or cryptography of this data.

FIG. 14 shows the third or the seventh modality of the remote device 150 attached to an adjustable elastic strap 82, which has Velcro™ strips or adhesive portions 83,84,85,86. These modalities are not restricted to use fastened onto one's body and inside an automotive vehicle, but can also be used in different places and situations. One example is using the remote device 150 together with electronic transducers (U.S. Pat. No. 6,838,610B2) or instrumental devices (PCT/BR2005/000209, PCT/BR2005/000210, and PCT/BR2006/000012), in which the user of the device 150 may be with a group of friends controlling the sounds which are produced by other devices/users.

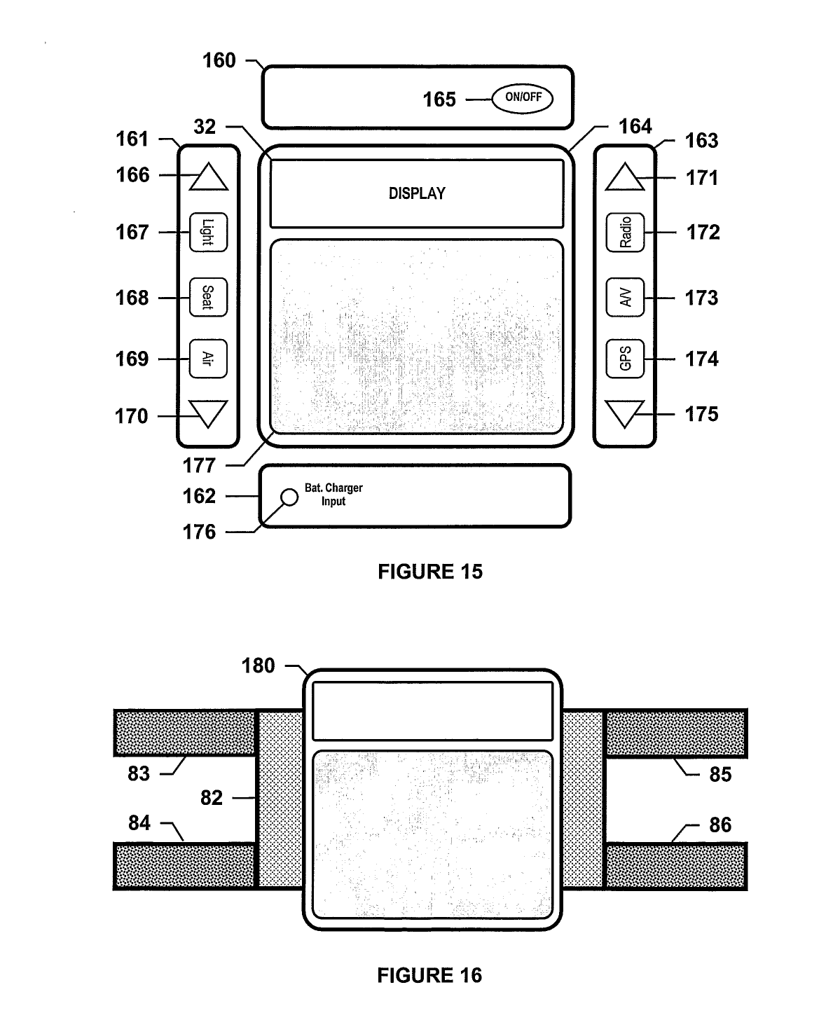

FIG. 15 shows the frontal 164, upper 160, lower 162, right 163, and left 161 lateral faces of the remote device 40. The upper face 160 has the ON/OFF key 165. The battery charger connector input 176 is located on the lower face 162. The graphic display 32 and the sensitive-to touch pad 177, are found on the frontal face. Some shortcut keys are located on both right and left lateral faces 163,161. On the left face 161 there is the Light key 167 for selection or adjustment of lighting or adjustment of the vehicle's lights, the Seat key 168 for seat adjustment, the AIR key 169 for acting on the air conditioning parameters and browsing arrows 170,166. In the same way, on the right face 163 there is the Radio key 172, which performs functions in the entertainment system 2, the A/V key 173, which allows access to the audio and video commands in the vehicle, the GPS key 174 to control the navigation system 12, and the browsing keys 171,175, which aid in the control of these shortcut keys. The remote device 180 can be fastened onto an adjustable elastic strap 82 with Velcro™ strips or adhesive portions 83,84,85,86, as shown in FIG. 16.

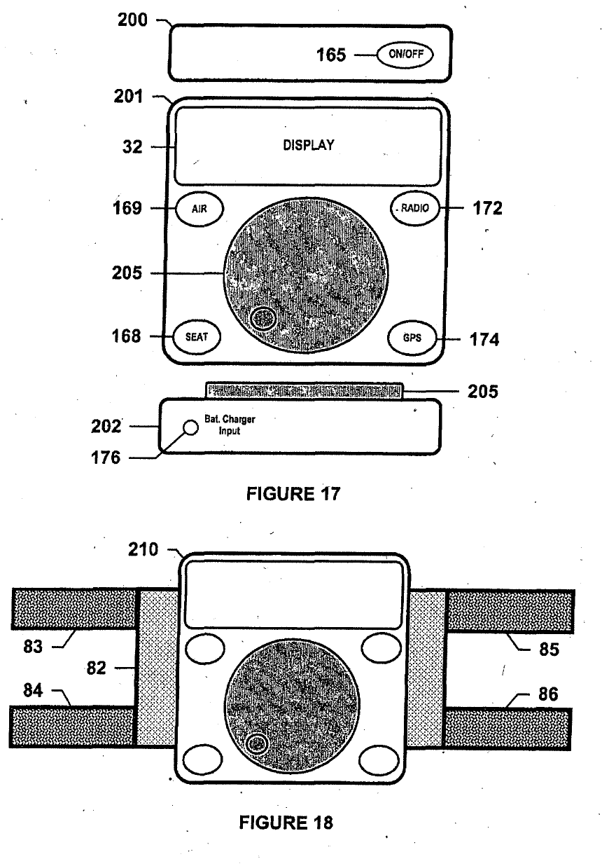

The frontal 201, upper 200 and lower lateral 202 faces of the fifth modality of the remote device are shown in FIG. 17. Similarly to the fourth modality, the upper lateral face 200 has an ON/OFF key 165, and the lower lateral face 202 has the battery charger input connector 176, pointing out that the multifunctional disc 205 sticks out from the frontal face surface 201. The graphic display 32, shortcut keys 168,169,172,174 and the multifunctional disc 205 are located on the frontal face. It is important to point out that this disc is sensible to the touch and rotation performed by the user. One of its applications is the selection and adjustment of a particular parameter, being that when rotating the disc it is possible to change the focus of selection, according to the icons shown on the display 32, and with a touch on its surface the user may select and adjust the parameter accordingly to the rotation performed on the multifunctional disc 205. The fifth modality of the remote device 210 can also be attached to an adjustable elastic strap 82 in order to fasten the device onto the use's body, as suggested in FIG. 18.

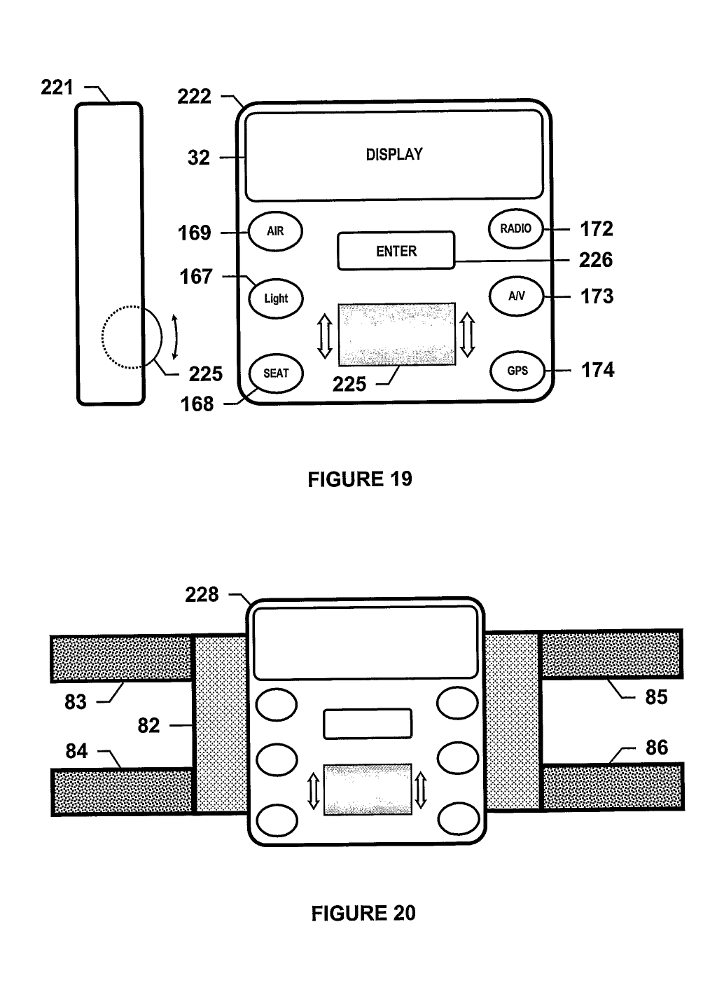

An external view of the sixth modality of the remote device 228 is seen in FIG. 19. The frontal face 222 has the graphic display 32, shortcut keys 168,169,172,173,174, a multifunctional roll 225, and the ENTER key 226, which confirms a selection or access a particular function. The multifunctional roll 225 consists of a plastic, rubber, or silicone cylinder, which enables the displacement of the selection focus, function selection, menus, submenus, to change parameter values, to make adjustments, among other possible functionalities. The left lateral face 221 shows that part of the roll 225 is prominent so that the user may roll it up or down as, for instance, when adjusting the radio volume. The user rotates the roll 225 to move the focus of selection until he finds the radio icon, which can be selected by pressing the roll 225 or the ENTER key 226. Then the radio options are shown and the volume adjustment function is selected. The volume is turned up by moving the roll 225 up, or turned down, moving it down. FIG. 20 presents the sixth modality of the remote device 228 attached to an adjustable elastic strap 82 with Velcro™ strips or adhesive portions 83,84,85,86.

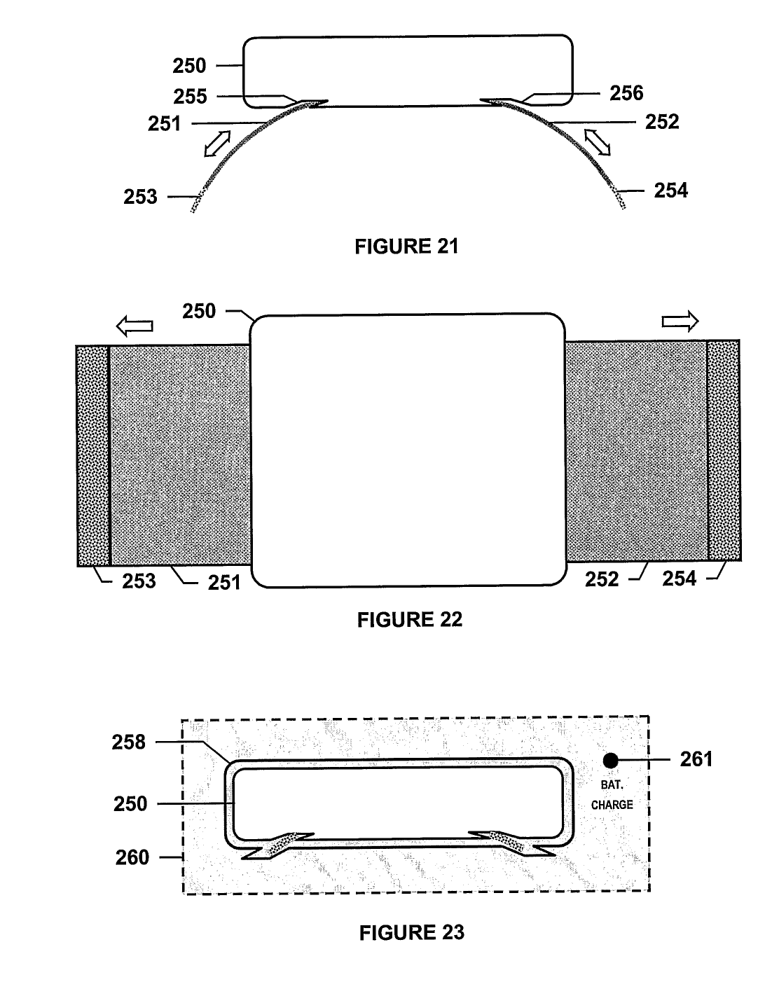

FIG. 21 presents the retractable and adjustable elastic strap 251,252 which may be applied to any of the seven modalities of the remote device 55,65,70,90,106,150,180,210,228, leaving the fixation methods for the adjustable elastic strap 82 out. In this modality of strap, the body of the device 250 has mechanisms to shelter, release and collect the strap 251,252, making the positioning on the user's body easier and more practical. Through the openings 255,256 in the back of the device 250, the strap 250 may be pulled though the strips 253,254 in order to be fastened onto the user's body. The strap 251,252 is pulled into the device 250 automatically through a spring mechanism, which applies a force to the strap 251,252 returns inside, and only the strips 253,254 remain outside. Then, if the user wishes to put the device 250 on his body, it is necessary to pull both sides of the strap 251,252, by means of the strips 253,254, in a way that the strap goes around the body and the strips 253,254 meet in order to be attached to each other. The retraction force applied on the strap will hold it firmly onto the user's body.

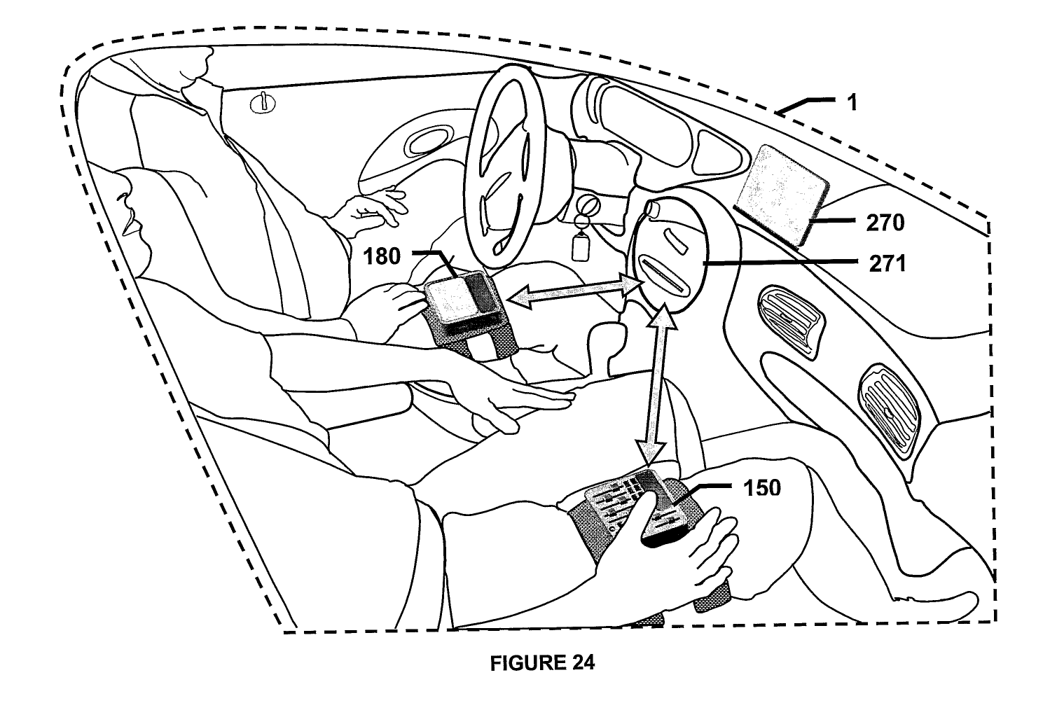

FIG. 22 shows an upper view of the retractable and adjustable elastic strap 251,252 away from the body of the device 250. The total length of the strap must be enough for the device 250 to be fastened onto any part of the user's body. Aiming at facilitating the arrangement and the battery recharge of this device 23, an affixation support 258 for the interior of the vehicle is suggested in FIG. 23, being one of the ideas of the present invention. The upper view of this set 260 shows that the support 258 has an appropriate shape so that the device 250 and the strips 253,254 can fit well inside it. A battery charge led 261 indicates that the device 250 was properly fitted into the support 258 and that the internal battery is being recharged. It is important to mention that the support 258 may be part of the vehicle or placed somewhere inside it, in a way of facilitating the placement and removal of the device 250. The support may be, for instance, next to the gear shift or on the vehicle's panel.

At last, FIG. 24 shows a view of the interior of an automotive vehicle 1 where the remote device referred to the fourth modality 180 is fastened onto the driver's body, and the one referred to the third modality 150 is fastened onto the passenger's body. The example given in this figure suggests that any of the modalities of the remote device 55,65,70,90,106,150,180,210,228 can be used, attached to the users' bodies as, for example, to their legs; located inside an automotive vehicle 1 wherein the devices 55,65,70,90,106,150,180, 210,228 are not coupled. The devices 150,180 are capable of interacting with the on-board computer and an entertainment system 271, since the visualization of the devices' 150,180 interaction may be seen in one of the graphic displays 270 available in the vehicle 1. There are many possibilities of use for the device of the present invention. An additional example consists of the occupants in the front of the vehicle 1 using remote devices 55,65,70,90,106, 150,180,210,228, in a similar way to the illustration in FIG. 24. Then the passengers on the back seat could use an electronic transducer, described by the granted U.S. Pat. No. 6,838,610B2; an instrumental device for vehicles, as patent application PCT/BR2005/000209; a portable instrumental device, described in PCT/BR2005/000210; or still using a cellular phone with instrumental and musical resources, as shown in detail in the patent application PCT/BR2006/000012.

All the modalities of the device 55,65,70,90,106,150,180,210, 228 are composed of a metal or plastic case, keys, connectors, display, rotating disc, pad, and also an adjustable 82 or retractable elastic strap 251,252, being that internally there are printed circuit boards, electronic components, electric wires/cables, rechargeable or non-rechargeable battery, graphic display, leds, communication modules, fixating supports, among other electronic and mechanical devices.

1-84. (canceled)

85. Control and signaling device for vehicles, to be used fastened onto a user's body and inside automotive vehicles that comprise an entertainment system, the control and signaling device for vehicles comprising a remote device connected to a fastening member for fastening the remote device onto the user's body, said remote device being structured and arranged to receive and send commands to the vehicle's entertainment system.

86. Control and signaling device for vehicles, according to claim 85, characterized in that the entertainment system comprises a portable sound system.

87. Control and signaling device for vehicles, according to claim 85, characterized in that the entertainment system comprises a video game.

88. Control and signaling device for vehicles, according to claim 85, characterized in that the entertainment system comprises an instrumental device.

89. Control and signaling device for vehicles, according to claim 85, characterized in that the entertainment system comprises a cellular phone.

90. Control and signaling device for vehicles, according to claim 85, characterized in that the remote device contains a communication system which is compatible with a communication system of the vehicle.

91. Control and signaling device for vehicles, according to claim 89, characterized in that the remote device contains a communication system which is compatible with a communication system of a cellular phone.

92. Control and signaling device for vehicles, according to claim 91 characterized in that the communication system of the remote device is able to establish bidirectional (two-way) communication by means of radio frequency, ultra sound, infrared light or electrical wires/cables.

93. Control and signaling device for vehicles, according to claim 85, characterized in that the fastening member comprises an adjustable elastic strap.

94. Control and signaling device for vehicles, according to claim 93, characterized in that the adjustable elastic strap contains strips or adhesive portions.

95. Control and signaling device for vehicles, according to claim 85, characterized in that the fastening member comprises an adjustable retractable elastic strap that comes out of the remote device.

96. Control and signaling device for vehicles, according to claim 95, characterized in that the adjustable and retractable elastic strap has strips or adhesive portions.

97. Control and signaling device for vehicles, according to claim 93, characterized in that the remote device can be attached to the adjustable elastic strap by means of two discs.

98. Control and signaling device for vehicles, according to claim 93, characterized in that the remote device is attached to the adjustable elastic strap by means of an articulated mechanism.

99. Control and signaling device for vehicles, according to claim 85, characterized in that the remote device permits to control a cursor from a display of the entertainment system of the vehicle.

100. Control and signaling device for vehicles, according to claim 99, characterized in that the display is a head up display.

101. Control and signaling device for vehicles, according to claim 85, characterized in that the remote device contains a vibration signaling system.

102. Control and signaling device for vehicles, according to claim 101, characterized in that the vibration signaling system contains a micro motor, solenoid or electromechanical device capable of emitting mechanical vibrations.

103. Control and signaling device for vehicles, according to claim 85, characterized in that the remote device contains a scroll button.

104. Control and signaling device for vehicles, according to claim 103, characterized in that the scroll button contains LEDs under its surface.

105. Control and signaling device for vehicles, according to claim 85, characterized in that the remote device contains a touch sensitive surface or pad.

106. Control and signaling device for vehicles, according to claim 105, characterized in that touch sensors are spread out under the pad.

107. Control and signaling device for vehicles, according to claim 106, characterized in that the touch sensors can be piezoelectric, capacitive, resistive, inductive, optical or field effect type.

108. Control and signaling device for vehicles, according to claim 106, characterized in that the touch sensors can be a pressure, force or position sensors type.

109. Control and signaling device for vehicles, according to claim 106, characterized in that the pad has LEDs under a surface.

110. Control and signaling device for vehicles, according to claim 85, characterized in that the remote device has shortcut keys on its sides.

111. Control and signaling device for vehicles, according to claim 85, characterized in that the remote device has a multifunctional disc or roll.

112. Control and signaling device for vehicles, according to claim 111, characterized in that the multifunctional disc or roll is sensitive to spin and sensitive to touch.

113. Control and signaling device for vehicles, according to claim 112, characterized in that the multifunctional disc or roll has position and/or angular speed sensors, or still optical, inductive or capacitive sensors.

114. Control and signaling device for vehicles, according to claim 113, characterized in that the multifunctional disc or roll has touch sensors which can be piezoelectric, capacitive, resistive, inductive, optical or field effect type.

115. Control and signaling device for vehicles, according to claim 113, characterized in that the multifunctional disc or roll has touch sensors which can be pressure, force or position sensors types.

116. Control and signaling device for vehicles, according to claim 114, characterized in that the multifunctional disc or roll has LEDs spread out under a surface.

117. Control and signaling device for vehicles, according to claim 85, characterized in that the remote device has sliding keys.

118. Control and signaling device for vehicles, according to claim 117, characterized in that the sliding keys are composed of resistive potentiometers, optical sensors of displacement, or any type of sliding adjustment.

119. Control and signaling device for vehicles, according to claim 85, characterized in that the remote device has audio adjustment channels.

120. Control and signaling device for vehicles, according to claim 119, characterized in that the sound is recorded in the form of data or file and stored in a flash memory.

121. Control and signaling device for vehicles, according to claim 119, characterized in that the remote device sounds results can be sent to external headphones.

122. Control and signaling device for vehicles, according to claim 119, characterized in that the remote device sounds results is sent to the entertainment system of the vehicle.

123. Control and signaling device for vehicles, according to claim 85, characterized in that the remote device receives commands from an electronic transducer.

124. Control and signaling device for vehicles, according to claim 85, characterized in that the remote device receives, process and adjust sounds from an instrumental device.

125. Control and signaling device for vehicles, according to claim 85, characterized in that the remote device has a memory card interface.

126. Control and signaling device for vehicles, according to claim 85, characterized in that the remote device has a computer interface.

127. Control and signaling device for vehicles, according to claim 85, characterized in that the remote device has a flash memory for storage data/files.

128. Control and signaling device for vehicles, according to claim 85, characterized in that the remote device mixes two or more sounds.

129. Control and signaling device for vehicles, according to claim 85, characterized in that the remote device is able to produce musical instruments sounds.

130. Control and signaling device for vehicles, according to claims 85, characterized in that the remote device sends commands to an instrumental device.

131. Control and signaling device for vehicles, according to claim 85, characterized in that the remote device sends sounds to an instrumental device.

132. Control and signaling device for vehicles, according to claim 85, characterized in that the remote device has an alphanumerical keyboard.

133. Control and signaling device for vehicles, according to claim 116, characterized in that the LEDs form geometrical figures.

134. Control and signaling device for vehicles, according to claim 85, characterized in that the remote device interacts with a cellular phone containing instrumental and musical resources.
